(19) United States
(12) Patent Application Publication
(10) Pub. No.: US 2024/0334273 A1
(43) Pub. Date: Oct. 3, 2024

(54) WIRELESS COMMUNICATION METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventor: Xin YOU, Dongguan (CN)

(73) Assignee: GUANGDONG OPPO MOBILE TELECOMMUNICATIONS CORP., LTD., Dongguan (CN)

(21) Appl. No.: 18/742,812

(22) Filed: Jun. 13, 2024

Related U.S. Application Data
(63) Continuation of application No. PCT/CN2021/137505, filed on Dec. 13, 2021.

(51) Int. Cl. H04W 36/00; H04W 36/08

(52) U.S. Cl. CPC H04W 36/0085; H04W 36/08

(57) ABSTRACT

Provided are a wireless communication method, a terminal device, and a network device. The wireless communication method includes: performing, by a terminal device, a handover from a source cell to a target cell, where the handover is a first handover, and the first handover is a handover triggered based on layer-1/layer-2 signaling or measurement.

### CROSS-REFERENCE TO RELATED APPLICATIONS

This application is a continuation of International Application No. PCT/CN2021/137505, filed on Dec. 13, 2021, the disclosure of which is hereby incorporated by reference in its entirety.

### TECHNICAL FIELD

This application relates to the field of communications technologies, and more specifically, to a wireless communication method, a terminal device, and a network device.

### RELATED ART

In related technologies, a conventional handover and a conditional handover are layer-3 handovers based on reporting from a terminal device and configuration by a network device. Exchange of a plurality of pieces of signaling between the terminal device and the network device causes a relatively large handover delay.

### SUMMARY

This application provides a wireless communication method, a terminal device, and a network device.

According to a first aspect, a wireless communication method is provided, including: performing, by a terminal device, a handover from a source cell to a target cell, where the handover is a first handover, and the first handover is a handover triggered based on layer-1/layer-2 signaling or measurement.

According to a second aspect, a wireless communication method is provided, including: transmitting, by a source cell, a handover request to a target cell, where the handover request is used to perform a handover of a terminal device from the source cell to the target cell, the handover is a first handover, and the first handover is a handover triggered based on layer-1/layer-2 signaling or measurement.

According to a third aspect, a terminal device is provided, including: a memory and a processor, wherein the memory is configured to store a program, and the processor is configured to invoke the program in the memory to cause the terminal device at least to: perform a handover from a source cell to a target cell, where the handover is a first handover, and the first handover is a handover triggered based on layer-1/layer-2 signaling or measurement.

### BRIEF DESCRIPTION OF DRAWINGS

FIG. 1 is an example diagram of an architecture of a wireless communications system to which embodiments of this application are applicable.

FIG. 2 is a schematic flowchart of an Xn interface-based handover according to an embodiment of this application.

FIG. 3 is a schematic flowchart of a handover triggered based on a condition according to an embodiment of this application.

FIG. 4 is a schematic flowchart of a wireless communication method according to an embodiment of this application.

FIG. 5 is a schematic flowchart of a wireless communication method according to another embodiment of this application.

FIG. 6 is a schematic flowchart of a wireless communication method according to still another embodiment of this application.

FIG. 7 is a schematic flowchart of a wireless communication method according to still another embodiment of this application.

FIG. 8 is a schematic flowchart of a wireless communication method according to still another embodiment of this application.

FIG. 9 is a schematic block diagram of a structure of a terminal device according to an embodiment of this application.

FIG. 10 is a schematic block diagram of a structure of a network device according to an embodiment of this application.

FIG. 11 is a schematic block diagram of a structure of a network device according to another embodiment of this application.

FIG. 12 is a schematic structural diagram of an apparatus according to an embodiment of this application.

### DESCRIPTION OF EMBODIMENTS

The following describes the technical solutions in this application with reference to the accompanying drawings.

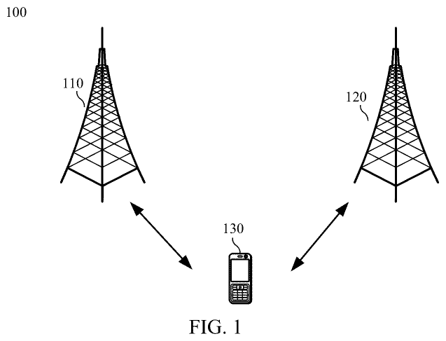

FIG. 1 shows a wireless communications system 100 to which embodiments of this application are applicable. The wireless communications system 100 may include at least two network devices, such as a network device 110 and a network device 120 shown in FIG. 1. The wireless communications system 100 may further include at least one terminal device, such as a terminal device 130 shown in FIG. 1. The terminal device 130 may be a mobile or fixed terminal device. The network device 110 and the network device 120 may be devices that communicate with the terminal device 130. The network device 110 and the network device 120 may provide communications coverage for specific geographic areas, and may communicate with the terminal device 130 located within the coverage (cell).

FIG. 1 exemplarily shows two network devices and one terminal device, but this should not constitute any limitation on this application. Optionally, the wireless communications system 100 may include more network devices, and another quantity of terminal devices may be included in coverage of each network device, which is not limited in embodiments of this application.

Optionally, the wireless communications system 100 may further include one or more core network devices, which is not limited in embodiments of this application. For example, the core network device may include, for example, one or more of the following: an access and mobility management function (AMF) entity, a session management function (SMF) entity, a user plane function (UPF) entity, or the like.

For example, the AMF entity may also be referred to as an AMF network element or an AMF functional entity. The AMF entity may be responsible for access management and mobility management for terminal devices.

For example, the SMF entity may also be referred to as an SMF network element or an SMF functional entity. The SMF entity may be responsible for session management (such as user session establishment), internet protocol (IP) address allocation and management for terminal devices, and the like.

For example, the UPF entity may also be referred to as an UPF network element or an UPF functional entity. The UPF entity may be a functional entity of a user plane, that is, a user plane gateway. The UPF entity may be used for packet routing and forwarding, or quality of service (QOS) processing of user plane data. User data may be accessed by an external network, such as a data network (DN), through the UPF entity.

Optionally, the wireless communications system 100 may further include another network entity such as a network controller, which is not limited in embodiments of this application.

It should be understood that technical solutions of embodiments of this application may be applied to various communications systems, such as a 5th generation (5G) system or a new radio (NR) system, a long term evolution (LTE) system, an LTE frequency division duplex (FDD) system, and LTE time division duplex (TDD). The technical solutions provided in this application may be further applied to a future communications system, such as a 6th generation mobile communications system or a satellite communications system.

The terminal device in embodiments of this application may also be referred to as user equipment (UE), an access terminal, a user unit, a user station, a mobile site, a mobile station (MS), a mobile terminal (MT), a remote station, a remote terminal, a mobile device, a user terminal, a terminal, a wireless communication device, a user agent, or a user apparatus. The terminal device in embodiments of this application may be a device providing a user with voice and/or data connectivity and capable of connecting people, objects, and machines, such as a handheld device or vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in smart city, a wireless terminal in smart home, or the like. Optionally, the UE may be used to act as a base station. For example, the UE may act as a scheduling entity, which provides a sidelink signal between UEs in V2X or D2D, or the like. For example, a cellular phone and a vehicle communicate with each other through a sidelink signal. A cellular phone and a smart home device communicate with each other, without the relay of a communication signal through a base station.

The network device in embodiments of this application may be a device for communicating with the terminal device. The network device may also be referred to as an access network device or a wireless access network device. For example, the network device may be a base station. The network device in embodiments of this application may be a radio access network (RAN) node (or device) that connects the terminal device to a wireless network. The base station may broadly cover various names in the following, or may be interchangeable with one of the following names, for example: a NodeB, an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a radio node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communication module, a modem, or a chip disposed in the device or apparatus described above. Alternatively, the base station may be a mobile switching center, a device that functions as a base station in device to device (D2D), vehicle-to-everything (V2X), and machine-to-machine (M2M) communications, a network-side device in a 6G network, a device that functions as a base station in a future communications system, or the like. The base station may support networks of the same or different access technologies. A specific technology and specific device form used by the network device are not limited in embodiments of this application.

The base station may be a fixed or mobile station. For example, a helicopter or an unmanned aerial vehicle may be configured to act as a mobile base station, and one or more cells may move depending on a position of the mobile base station. In other examples, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of the communication device in this application may also be implemented by software functions running on hardware, or by virtualization functions instantiated on a platform (for example, a cloud platform).

To facilitate understanding of embodiments of this application, the following first describes terms related in embodiments of this application.

### Cell

A cell is described at a higher layer from the perspective of resource management or mobility management or a service unit. A coverage area of each network device may be divided into one or more cells, and each cell may correspond to one or more frequencies. In other words, each cell may be considered as an area formed by a coverage area of one or more frequencies.

It should be noted that a cell may refer to an area within a wireless coverage area of a network device. In embodiments of this application, different cells may correspond to the same network device or different network devices. For example, a network device to which cell #1 belongs and a network device to which cell #2 belongs may be a same network device; for example, cell #1 and cell #2 may be managed by a same base station. Alternatively, the network device to which cell #1 belongs and the network device to which cell #2 belongs may be different network devices, for example, cell #1 and cell #2 may be managed by different base stations. This is not specifically limited in embodiments of this application.

### Handover (HO)

In a wireless communications system (such as an LTE system or an NR system), when a terminal device that is using a network service moves from one cell to another cell, or due to reasons such as load adjustment of a wireless transmission service, activation operation and maintenance, and a device fault, to ensure continuity and quality of service of communication of the terminal device, the system needs to transfer a communication link between the terminal device and an original cell to a new cell, that is, perform a handover.

There may be a plurality of types of handovers. For example, based on interfaces between different network devices, the handovers may include X2 interface-based handover, Xn interface-based handover, and the like. In order to improve robustness during a handover process of the terminal device, the handovers may further include conditional handover.

### Source Cell and Target Cell

In embodiments of this application, a source cell may refer to a cell that provides a service to a terminal device before a handover. A target cell may refer to a cell that provides a service to the terminal device after a handover.

It should be understood that a cell may refer to a coverage area of a network device, that is, a cell corresponds to a network device. In other words, in embodiments of this application, the source cell corresponds to a source network device (for example, a source base station), and the target cell corresponds to a target network device (for example, a target base station).

It should be further understood that in embodiments of this application, “source cell” may be replaced by “network device to which the source cell belongs”, and “target cell” may be replaced by “network device to which the target cell belongs”.

It should be further understood that in embodiments of this application, the source cell and the target cell may belong to a same network device (such as base station), or the source cell and the target cell may belong to different network devices. In other words, in some embodiments, the source network device and the target network device may refer to a same network device. This is not limited in embodiments of this application.

In embodiments of this application, the source cell may be distinguished from the target cell by using different information. By way of example but not limitation, the source cell may be distinguished from the target cell by using at least one of following information:
(1) different cell identifiers, where the cell identifier may refer to, for example, a cell global identifier (CGI), or a physical cell identifier (PCI); (2) different transmission-reception points (TRP); (3) different reference signal sets; (4) different resources, such as different control resource sets (coreset) or different control resource set pools (coreset pool); (5) different hybrid automatic repeat request (HARQ) processes; (6) different protocol stacks, such as a protocol stack at a service data adaptation protocol (SDAP) layer, a protocol stack at a packet data convergence protocol (PDCP) layer, a protocol stack at a radio link control (RLC) layer, a protocol stack at a medium access control (MAC) layer, and a protocol stack at a physical layer (PHY); and (7) different transmission configuration indicator (TCI) states.

For the source cell, target cell, source network device, and target network device mentioned below, refer to the foregoing description. Details are not described again.

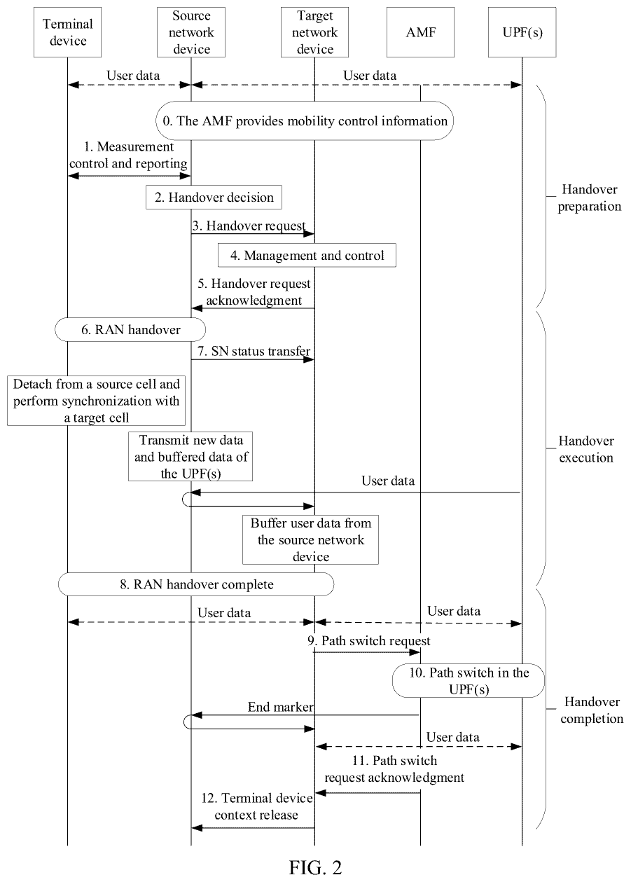

In a conventional handover procedure, an entire handover process may be divided into three phases: handover preparation, handover execution, and handover completion. The following briefly describes a conventional handover process with reference to FIG. 2 by using the Xn interface-based handover process as an example.

### Phase 1: Handover Preparation (Step 1 to Step 5)

In step 1, measurement control and reporting are performed between a source network device and a terminal device. Specifically, the source network device triggers the terminal device to measure a neighboring cell, so that the terminal device may measure the neighboring cell, and report a measurement result to the source network device.

In step 2, the source network device evaluates the measurement result reported by the terminal device, to determine whether to trigger a handover.

In step 3, if the source network device determines to trigger a handover, the source network device may transmit a handover request to a target network device.

In step 4, after receiving the handover request transmitted by the source network device, the target network device may start access admission according to service information carried by the source network device, and perform radio resource configuration.

In step 5, the target network device transmits a handover request acknowledgment message to the source network device. The handover request acknowledgment message includes a handover command generated by the target network device. The source network device directly forwards the handover command to the terminal device without allowing any modification of the handover command generated by the target network device. At this point, the handover preparation phase is completed.

### Phase 2: Handover Execution (Step 6 to Step 8)

In step 6, after receiving the handover request acknowledgment message from the target network device, the source network device may trigger the terminal device to perform a handover.

In step 7, the source network device may forward, to the target network device, buffered data, a data packet in transit, an associated sequence number (SN) of data, and the like.

In addition, the terminal device may detach from the source network device and attach to the target cell (for example, perform random access, transmit a radio resource control (RRC) handover complete message to the target network device).

In step 8, the terminal device performs synchronization with the target network device. At this point, the handover execution phase is completed.

### Phase 3: Handover Completion (Step 9 to Step 12)

In step 9, the target network device transmits a path switch request to an AMF.

In step 10, after receiving the path switch request from the target network device, the AMF executes path switch with a UPF, to clear a path mark of a user plane of the source network device.

In step 11, after the path switch is completed, the AMF may transmit a path switch acknowledgment message to the target network device.

In step 12, the target network device transmits a terminal device context release message to the source network device, to notify the source network device that the handover succeeds, and to trigger the source network device to release a context of the terminal device. At this point, the handover is completed.

In some embodiments, for some special scenarios, for example, when the terminal device moves at a high speed or at a high frequency, a handover needs to be performed frequently. Based on this, the third generation partnership project (3GPP) introduced a conditional triggering based handover process (also referred to as conditional handover (CHO)) in release 16 (R16), which can avoid an excessively long switching preparation time that causes an excessively late handover of the terminal device.

In a conditional handover, a handover command may be configured in advance for the terminal device. In addition, for high-speed rail scenarios, a travel trajectory of the terminal device is specific. Therefore, the source network device may configure a target network device for the terminal device in advance, and the handover command may include a condition for triggering a handover of the terminal device. When the handover condition is satisfied, the terminal device may initiate an access request to the target network device. In other words, the conditional handover may support configuration of a plurality of candidate cells in the handover command, so that the terminal device may determine a specific target cell for access based on a configured condition.

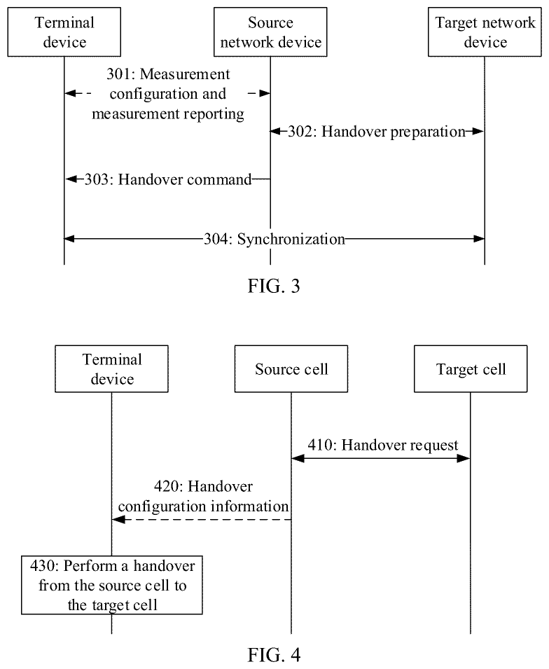

Specifically, for the conditional handover process, refer to FIG. 3. As shown in FIG. 3, in step 301, a source network device transmits information about a measurement configuration to a terminal device, and the terminal device performs measurement reporting based on the measurement configuration. In step 302, handover preparation information is exchanged between the source network device and a target network device. In step 303, the source network device transmits a conditional handover command to the terminal device, where the conditional handover command may carry a handover condition of a cell. In step 304, when the conditional handover command is satisfied, the terminal device implements synchronization with the target network device.

However, the conventional handover and conditional handover mentioned above are based on reporting from the terminal device and configuration by the network device. Exchange of a plurality of pieces of signaling between the terminal device and the network device causes a relatively large handover delay.

To resolve the foregoing problem, an embodiment of this application provides a wireless communication method, so that a terminal device can perform a first handover, where the first handover is a handover triggered based on layer-1/layer-2 signaling or measurement. The first handover is a handover based on a bottom layer, which can reduce signaling overheads, and can further reduce a quantity of transmission layers in a protocol stack. Therefore, the first handover is one of solutions for reducing a handover delay. The following describes embodiments of this application in detail with reference to the accompanying drawings.

FIG. 4 is a schematic flowchart of a wireless communication method according to an embodiment of this application. The method shown in FIG. 4 is described from the perspective of interaction between a terminal device, a source cell, and a target cell. The terminal device may be, for example, the terminal device 130 shown in FIG. 1, the source cell corresponds to a source network device, and the target cell corresponds to a target network device. The source network device and the target network device may be, for example, the network devices 110 and 120 shown in FIG. 1. For detailed content of the source cell and the target cell, refer to the foregoing description. Details are not described herein again.

In step 410, the source cell transmits a handover request to the target cell. The handover request is used to perform a handover of the terminal device from the source cell to the target cell.

In an implementation, the source cell may transmit a handover request to one or more candidate cells. The target cell is one cell of the one or more candidate cells.

In some embodiments, after receiving the handover request, the candidate cell may start access admission according to service information carried by the source cell, and perform radio resource configuration.

In some embodiments, after receiving the handover request, the candidate cell may further transmit a handover request acknowledgment message to the source cell.

In some embodiments, after receiving the handover request acknowledgment message transmitted by the candidate cell, the source cell may make a handover decision (first handover decision) based on the handover request acknowledgment message.

In step 430, the terminal device performs a handover from the source cell to the target cell. The handover is a first handover, and the first handover is a handover triggered based on layer-1/layer-2 signaling or measurement.

In an implementation, that the terminal device performs a handover from the source cell to the target cell may mean that the terminal device releases a connection to the source cell and performs synchronization with the target cell. For example, the terminal device may perform a random access procedure to perform synchronization with the target cell. Furthermore, the terminal device may transmit an RRC handover complete message to the source cell to indicate the source cell to detach from the terminal device.

It should be understood that in step 430, that the terminal device performs a handover from the source cell to the target cell does not mean that the terminal device can be definitely handed over to the target cell successfully, or does not mean that the terminal device can definitely access the target cell successfully. In other words, in step 430, that the terminal device performs a handover from the source cell to the target cell may mean that after determining the target cell to which the terminal can be handed over, the terminal device attempts to perform a handover or to access the target cell.

In embodiments of this application, the terminal device may perform the first handover triggered based on layer-1/layer-2 signaling or measurement, to reduce signaling overheads and a quantity of transmission layers in a protocol stack, thereby reducing a handover delay.

In some embodiments, the handover (first handover) is determined based on the layer-1 measurement. In some other embodiments, the handover is determined based on layer-3 measurement. Specific content of the layer-1 measurement and the layer-3 measurement is described subsequently, and is not described herein.

In some embodiments, the handover (first handover) is triggered based on first information received by the terminal device, and the first information is used to indicate the terminal device to perform a handover from the source cell to the target cell. In other words, after receiving a handover command transmitted by the source cell, the terminal device may perform the first handover based on the handover command, to achieve a handover from the source cell to the target cell. Optionally, the handover command may include related information of the target cell, for example, an identifier of the target cell.

In an implementation, after determining the target cell to which the terminal device can be handed over, the terminal device may report the target cell to the source cell, and the source cell transmits the first information to indicate the terminal device to perform a handover. For example, when the terminal device determines that the target cell satisfies a first condition, the terminal device may transmit second information to the source cell. After receiving the second information, the source cell may transmit the first information (the first information may also be referred to as response information for the second information) to the terminal device based on the second information. The first information is used to indicate the terminal device to perform a handover from the source cell to the target cell.

In some embodiments, the second information is used to report a first measurement result to the source cell. The first measurement result may be a layer-1 measurement result, or may be a layer-3 measurement result. After receiving the first measurement result, the source cell may determine, based on the first measurement result, the target cell to be accessed by the terminal device. In some embodiments, the second information may be indication information, indicating that there is a target cell satisfying the first condition, and the source cell may determine, based on the indication information, a target cell to be accessed by the terminal device. The first condition is that the terminal device determines whether the target cell satisfies a condition for performing the handover/measurement reporting. Specific content of the first condition is described subsequently, and is not described herein.

In some embodiments, the second information may include information representing an identity of the target cell. For example, the second information may include an identifier (such as CGI or PCI) of the target cell. Optionally, the second information may further include a TCI state of the target cell, or beam related information of the target cell, or the like.

In some embodiments, the first information and the second information may be carried in a MAC layer control element (CE) message, which may be briefly referred to as a MAC CE message. In some embodiments, the first information may be carried in downlink control information (DCI). In other words, the source cell may transmit the first information to the terminal device through a physical downlink control channel (PDCCH). The second information may be carried in uplink control information (UCI). In other words, the terminal device may report the second information to the source cell through a physical uplink control channel (PUCCH).

In some embodiments, the handover of the terminal device from the source cell to the target cell is triggered based on a first condition, and the first condition is that the terminal device determines whether the target cell satisfies a condition for performing the handover/measurement reporting. In other words, after determining the target cell to which the terminal device can be handed over, the terminal device may autonomously trigger a handover, to achieve a handover from the source cell to the target cell. Specifically, in an implementation, when the terminal device determines that the target cell satisfies the first condition, the terminal device may detach from the source cell, apply a configuration corresponding to the target cell, and perform synchronization with the target cell (for example, perform random access).

Specifically, in an implementation, the terminal device may determine, based on a first condition corresponding to a candidate cell, whether the candidate cell satisfies the first condition for performing the first handover, or in other words, the terminal device may evaluate the candidate cell based on the first condition. If a determining or evaluation result is that one or some candidate cells satisfy the first condition, the candidate cell may be determined as the target cell. Then, the terminal device may consider a handover to the target cell.

It should be noted that, in some embodiments, the first condition may be shared by one or more candidate cells. To be specific, when there are a plurality of candidate cells, the plurality of candidate cells may correspond to the same first condition. In some embodiments, the first condition may alternatively be at a cell level. To be specific, when there are a plurality of candidate cells, the plurality of candidate cells may have corresponding first conditions respectively.

In some embodiments, when the handover is the first handover based on the layer-1 measurement, the first condition may be a condition for the layer-1 measurement. By way of example but not limitation, the first condition may be a condition for the layer-1 measurement, such as a block error ratio (BLER), a channel state information reference signal (CSI-RS), or a pathloss. For example, the first condition may include at least one of following conditions.
(1) At least one beam in a first beam set satisfies a first threshold (also referred to as a first threshold value, where all thresholds mentioned below may be referred to as threshold values). It should be noted that the first beam set may be a beam set of the source cell. For example, this may mean that at least N beams in the beam set of the source cell are less than the first threshold, where N is a positive integer. The first beam set may alternatively be a beam set of the target cell. For example, this may mean that at least N beams in the beam set of the target cell are greater than the first threshold. It should be noted that a type of a signal in the first beam set is not specifically limited in embodiments of this application. For example, the first beam set may include at least one of following signals: a synchronization signal block (SSB), or a CSI-RS, an uplink sounding reference signal (SRS), or the like.
(2) A BLER of the source cell exceeds a second threshold for N consecutive times, where N is a positive integer. A higher BLER of the source cell and a more frequent BLER occurrence indicate poorer signal quality of the source cell. In this case, a handover of the terminal device may be considered. In an example, when the BLER of the source cell exceeds 3% for five consecutive times, the terminal device performs a handover from the source cell to the target cell. It should be noted that in some embodiments, the first condition may alternatively be that the BLER of the source cell is greater than the second threshold within a time T, where T>0. In an example, when the BLER of the source cell exceeds 3% within 2 seconds, the terminal device performs a handover from the source cell to the target cell.
(3) A measurement value of at least one beam in a first beam set within a time Tis less than/greater than a third threshold, where T>0. It should be noted that the measurement value of the at least one beam may be a measurement value of the source cell. For example, this may mean that a measurement value of a CSI-RS of the source cell is less than the third threshold. The measurement value of the at least one beam may alternatively be a measurement value of the target cell. For example, this may mean that a measurement value of a CSI-RS of the target cell is greater than the third threshold. For specific content of the first beam set, refer to the foregoing description. Details are not described herein again.
(4) A difference between a measurement value of the source cell and a measurement value of the target cell is greater than a fourth threshold. The measurement values of the source cell and the measurement value of the target cell are not specifically limited in this application, and may be, for example, measurement values of a BLER, a CSI-RS/SSB, or a pathloss.

In some embodiments, when the measurement value of the source cell is less than the measurement value of the target cell, and a difference between the measurement value of the source cell and the measurement value of the target cell is greater than the fourth threshold, the terminal device performs a handover from the source cell to the target cell. For example, when a measurement value of a CSI-RS of the source cell is less than a measurement value of a CSI-RS of the target cell by the fourth threshold, the terminal device performs a handover from the source cell to the target cell. In some embodiments, when the measurement value of the source cell is greater than the measurement value of the target cell, and a difference between the measurement value of the source cell and the measurement value of the target cell is greater than the fourth threshold, the terminal device performs a handover from the source cell to the target cell. For example, when a measurement value of a BLER of the source cell is greater than a measurement value of a BLER of the target cell by the fourth threshold, the terminal device performs a handover from the source cell to the target cell.

It should be noted that, if the condition that the measurement value of the source cell is less/greater than the measurement value of the target cell is employed, the measurement value of the source cell and the measurement value of the target cell should be based on same measurement signals, for example, a comparison is made based on measurement values of CSI-RSs of the source cell and the target cell, or a comparison is made based on measurement values of CSI-RSs and pathlosses of the source cell and the target cell.

It should be noted that, in some embodiments, the fourth threshold is equal to 0. In other words, a handover of the terminal device from the source cell to the target cell may be possibly performed, provided that a measurement signal of the target cell is better than a measurement signal of the source cell. In some embodiments, the fourth threshold is greater than 0. In other words, a handover of the terminal device from the source cell to the target cell may be possibly performed when a measurement signal of the target cell is much better than a measurement signal of the source cell.
(5) A measurement value of the source cell is less than a fifth threshold, and a measurement value of the target cell is greater than a sixth threshold. For related description of the measurement value of the source cell and the measurement value of the target cell, refer to the foregoing description. It should be noted that, in some embodiments, the fifth threshold is equal to the sixth threshold. In other words, a handover of the terminal device from the source cell to the target cell may be possibly performed, provided that a measurement signal of the target cell is better than a measurement signal of the source cell. In some embodiments, the fifth threshold is less than the sixth threshold. For example, when the measurement value is a measurement value of a CSI-RS, the measurement value of the source cell may be less than the fifth threshold, and the measurement value of the target cell may be greater than the sixth threshold.
(6) A measurement value of the source cell is greater than a seventh threshold, and a measurement value of the target cell is less than an eighth threshold. In this embodiment, the seventh threshold may be equal to the eighth threshold, or the seventh threshold may be greater than the eighth threshold. For example, when the measurement value is a measurement value of a BLER, the measurement value of the source cell may be greater than the seventh threshold, and the measurement value of the target cell may be less than the eighth threshold.

In some embodiments, when the handover is the first handover based on the layer-3 measurement, the first condition may be a condition for the layer-3 measurement. In this embodiment, the first condition may be a layer-3 measurement event. By way of example but not limitation, the first condition may include, but is not limited to, for example, an A1 measurement event, an A2 measurement event, an A3 measurement event, an A4 measurement event, an A5 measurement event, a B1 measurement event, or a B2 measurement event. The A3 measurement event may specifically mean that cell signal quality of the target cell is higher than cell signal quality of the source cell by a preset first threshold. The A5 measurement event may specifically mean that cell signal quality of the target cell is higher than a preset second threshold, and cell signal quality of the source cell is lower than a preset third threshold. For specific description of each measurement event, refer to the prior art. For brevity, details are not described herein.

In some embodiments, the source cell may indicate the first condition to the terminal device through a MAC CE message. In some embodiments, the source cell may indicate the first condition to the terminal device through DCI.

In some embodiments, before step 430, step 420 may be further included in embodiments of this application. In step 420, the source cell transmits handover configuration information to the terminal device, where the handover configuration information may include configuration information of one or more candidate cells.

Specific content of the configuration information of the candidate cell is not limited in embodiments of this application. By way of example but not limitation, the configuration information of the candidate cell may include an identifier (such as CGI or PCI) of the candidate cell, random access channel (RACH) resource information for accessing the candidate cell, frequency information corresponding to the candidate cell, a physical layer configuration parameter, a MAC layer configuration parameter, an RLC layer configuration parameter, an RRC layer configuration parameter corresponding to the candidate cell, bearer configuration information, and the like.

In some embodiments, the handover configuration information transmitted by the source cell to the terminal device further includes a first condition corresponding to one or more candidate cells. The first condition is that the terminal device determines whether the one or more candidate cells satisfy a condition for performing the handover/measurement reporting. For specific content of the first condition, refer to the foregoing description. Details are not described herein again.

In some embodiments, the handover configuration information is transmitted by the source cell to the terminal device through high-layer signaling. For example, the high layer signaling may be RRC signaling. In an example, handover configuration information may be carried in an RRC reconfiguration message.

In some embodiments, measurement control and reporting may be further performed between the source cell and the terminal device. For example, the source cell may trigger the terminal device to measure a neighboring cell, so that after measuring the neighboring cell, the terminal device may report a measurement result to the source cell. In an example, content of the measurement on the neighbor cell by the terminal device may include a measurement frequency, a measurement identifier, and the like, which is not limited in this application.

In some embodiments, after the terminal device reports the measurement result to the source cell, the terminal device may determine to perform a handover based on the measurement result and/or radio resource management (RRM) information.

In some embodiments, the source cell is distinguished from the target cell by using different cell identities, different TRPs, different reference signal sets, different resources, different HARQ processes, different protocol stacks, different TCI states, or the like.

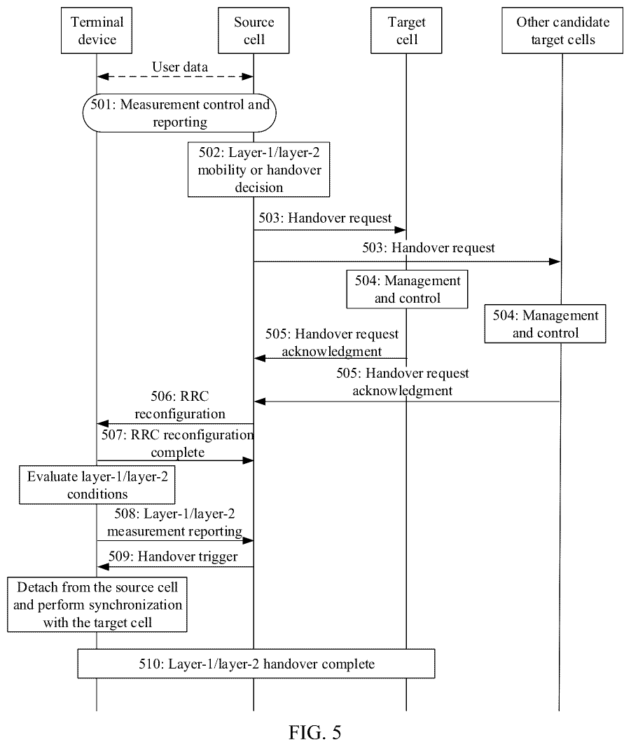

For ease of understanding, several possible specific embodiments of the wireless communication method of this application are given below with reference to FIG. 5 to FIG. 8 based on the method described in FIG. 4. It should be noted that steps of an entire handover process in the following embodiments are described as examples, and should not be construed as a limitation on this application. For example, an execution order is not limited, and it does not mean that any step in the handover process must be performed.

### Embodiment 1: Layer-1 Measurement+Reporting

FIG. 5 is a schematic flowchart of another wireless communication method according to an embodiment of this application.

As shown in FIG. 5, in step 501, measurement control and reporting are performed between a source cell and a terminal device. Specifically, the source cell may configure a measurement procedure for the terminal device, and the terminal device performs measurement and reporting according to the measurement configuration.

In step 502, the source cell determines, based on a measurement result reported by the terminal device and/or RRM information, whether to trigger a handover.

In step 503, if the source cell determines to trigger a handover, the source cell may transmit a handover request to one or more candidate cells.

In step 504, after receiving the handover request transmitted by the source cell, the candidate cell may start access admission according to service information carried by the source cell, and perform radio resource configuration.

In step 505, the candidate cell transmits a handover request acknowledgment message to the source cell.

Then, the source cell may make a first handover decision based on the handover request acknowledgment message from the candidate cell.

In step 506, if the source cell determines to perform a first handover, after receiving the handover request acknowledgment message from the candidate cell, the source cell may transmit a first handover configuration to the terminal device based on the handover request acknowledgment message, and the first handover configuration may be carried in an RRC reconfiguration message.

Optionally, the first handover configuration may include configuration information of the one or more candidate cells and a first condition corresponding to the one or more candidate cells. The first condition may be used by the terminal device to evaluate whether the candidate cell satisfies a condition for performing the handover/measurement reporting.

In step 507, the terminal device transmits an RRC reconfiguration complete message to the source cell. In addition, the terminal device may evaluate, based on the first condition, the one or more candidate cells transmitted by the source cell, and determine whether the candidate cell satisfies the first condition.

In this embodiment, the first condition is based on layer-1 measurement, for example, may be based on measurement evaluation of a BLER, a CSI-RS/SSB, or a pathloss. For specific content of the first condition, refer to the foregoing description.

In step 508, when there is a candidate cell satisfying the first condition, the terminal device may transmit second information to the source cell, and the second information may be used to report a first measurement result (current measurement result); or the second information may be indication information, indicating that there is currently a candidate cell satisfying the first condition.

Optionally, the second information may further include an identifier of the candidate cell that satisfies the first condition.

Optionally, the second information may be a MAC CE message or UCI.

In step 509, the source cell indicates, based on the second information transmitted by the terminal device, the terminal device to start a handover, and a handover command is used to indicate the terminal device to perform a handover to a target cell. Optionally, the handover command may include an identifier of the target cell.

In step 510, the terminal device releases a connection to the source cell, and performs synchronization with the target cell applying a corresponding configuration of the target cell, to complete the first handover.

### Embodiment 2: Layer-1 Measurement+Handover Triggered by Terminal Device

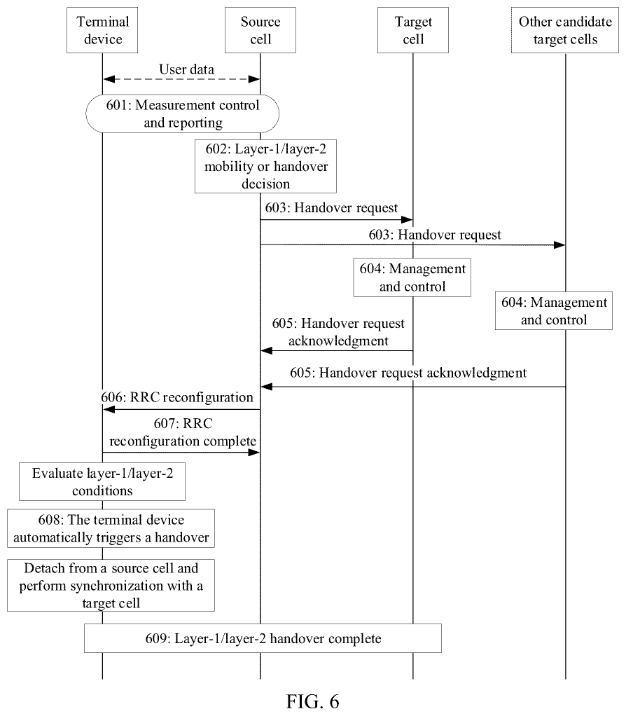

FIG. 6 is a schematic flowchart of another wireless communication method according to an embodiment of this application.

As shown in FIG. 6, in step 601, measurement control and reporting are performed between a source cell and a terminal device. Specifically, the source cell may configure a measurement procedure for the terminal device, and the terminal device performs measurement and reporting according to the measurement configuration.

In step 602, the source cell determines, based on a measurement result reported by the terminal device and/or RRM information, whether to trigger a handover.

In step 603, if the source cell determines to trigger a handover, the source cell may transmit a handover request to one or more candidate cells.

In step 604, after receiving the handover request transmitted by the source cell, the candidate cell may start access admission according to service information carried by the source cell, and perform radio resource configuration.

In step 605, the candidate cell transmits a handover request acknowledgment message to the source cell.

Then, the source cell may make a first handover decision based on the handover request acknowledgment message from the candidate cell.

In step 606, if the source cell determines to perform a first handover, after receiving the handover request acknowledgment message from the candidate cell, the source cell may transmit a first handover configuration to the terminal device based on the handover request acknowledgment message, and the first handover configuration may be carried in an RRC reconfiguration message.

Optionally, the first handover configuration may include configuration information of the one or more candidate cells and a first condition corresponding to the one or more candidate cells. The first condition may be used by the terminal device to evaluate whether the candidate cell satisfies a condition for performing the handover/measurement reporting.

In step 607, the terminal device transmits an RRC reconfiguration complete message to the source cell. In addition, the terminal device may evaluate, based on the first condition, the one or more candidate cells transmitted by the source cell, and determine whether the candidate cell satisfies the first condition.

In this embodiment, the first condition is based on layer-1 measurement, for example, may be based on measurement evaluation of a BLER, a CSI-RS/SSB, or a pathloss. For specific content of the first condition, refer to the foregoing description.

In step 608, when there is a candidate cell satisfying the first condition, the terminal device uses the candidate cell as a target cell, releases a connection to the source cell, and performs synchronization with the target cell applying a corresponding configuration of the target cell, to complete the first handover.

### Embodiment 3: Layer-3 Measurement+Reporting

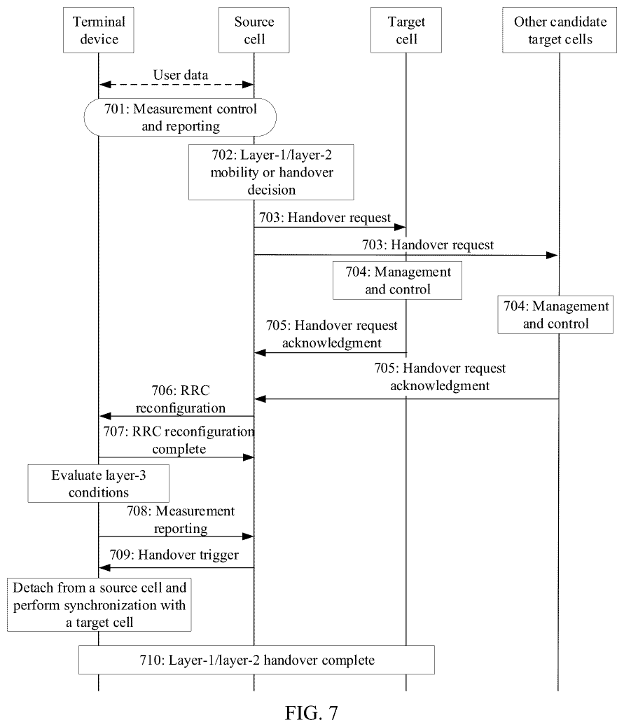

FIG. 7 is a schematic flowchart of another wireless communication method according to an embodiment of this application.

As shown in FIG. 7, in step 701, measurement control and reporting are performed between a source cell and a terminal device. Specifically, the source cell may configure a measurement procedure for the terminal device, and the terminal device performs measurement and reporting according to the measurement configuration.

In step 702, the source cell determines, based on a measurement result reported by the terminal device and/or RRM information, whether to trigger a handover.

In step 703, if the source cell determines to trigger a handover, the source cell may transmit a handover request to one or more candidate cells.

In step 704, after receiving the handover request transmitted by the source cell, the candidate cell may start access admission according to service information carried by the source cell, and perform radio resource configuration.

In step 705, the candidate cell transmits a handover request acknowledgment message to the source cell.

Then, the source cell may make a first handover decision based on the handover request acknowledgment message from the candidate cell.

In step 706, if the source cell determines to perform a first handover, after receiving the handover request acknowledgment message from the candidate cell, the source cell may transmit a first handover configuration to the terminal device based on the handover request acknowledgment message, and the first handover configuration may be carried in an RRC reconfiguration message.

Optionally, the first handover configuration may include configuration information of the one or more candidate cells and a first condition corresponding to the one or more candidate cells. The first condition may be used by the terminal device to evaluate whether the candidate cell satisfies a condition for performing the handover/measurement reporting.

In step 707, the terminal device transmits an RRC reconfiguration complete message to the source cell. In addition, the terminal device may evaluate, based on the first condition, the one or more candidate cells transmitted by the source cell, and determine whether the candidate cell satisfies the first condition.

In this embodiment, the first condition is based on layer-3 measurement, and may be, for example, an A3 measurement event or an A5 measurement event. For specific content of the first condition, refer to the foregoing description.

In step 708, when there is a candidate cell satisfying the first condition, the terminal device may transmit second information to the source cell, and the second information may be used to report a first measurement result (current measurement result); or the second information may be indication information, indicating that there is currently a candidate cell satisfying the first condition.

Optionally, the second information may further include an identifier of the candidate cell that satisfies the first condition.

Optionally, the second information may be a MAC CE message or UCI.

In step 709, the source cell indicates, based on the second information transmitted by the terminal device, the terminal device to start a handover, and a handover command is used to indicate the terminal device to perform a handover to a target cell. Optionally, the handover command may include an identifier of the target cell.

In step 710, the terminal device releases a connection to the source cell, and performs synchronization with the target cell applying a corresponding configuration of the target cell, to complete the first handover.

### Embodiment 4: Layer-3 Measurement+Handover Triggered by Terminal Device

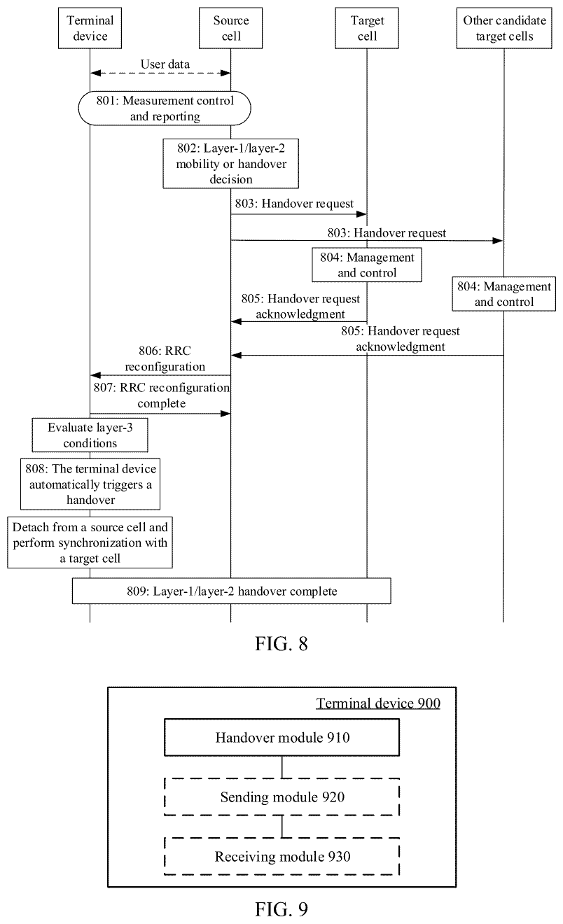

FIG. 8 is a schematic flowchart of another wireless communication method according to an embodiment of this application.

As shown in FIG. 8, in step 801, measurement control and reporting are performed between a source cell and a terminal device. Specifically, the source cell may configure a measurement procedure for the terminal device, and the terminal device performs measurement and reporting according to the measurement configuration.

In step 802, the source cell determines, based on a measurement result reported by the terminal device and/or RRM information, whether to trigger a handover.

In step 803, if the source cell determines to trigger a handover, the source cell may transmit a handover request to one or more candidate cells.

In step 804, after receiving the handover request transmitted by the source cell, the candidate cell may start access admission according to service information carried by the source cell, and perform radio resource configuration.

In step 805, the candidate cell transmits a handover request acknowledgment message to the source cell.

Then, the source cell may make a first handover decision based on the handover request acknowledgment message from the candidate cell.

In step 806, if the source cell determines to perform a first handover, after receiving the handover request acknowledgment message from the candidate cell, the source cell may transmit a first handover configuration to the terminal device based on the handover request acknowledgment message, and the first handover configuration may be carried in an RRC reconfiguration message.

Optionally, the first handover configuration may include configuration information of the one or more candidate cells and a first condition corresponding to the one or more candidate cells. The first condition may be used by the terminal device to evaluate whether the candidate cell satisfies a condition for performing the handover/measurement reporting.

In step 807, the terminal device transmits an RRC reconfiguration complete message to the source cell. In addition, the terminal device may evaluate, based on the first condition, the one or more candidate cells transmitted by the source cell, and determine whether the candidate cell satisfies the first condition.

In this embodiment, the first condition is based on layer-3 measurement, and may be, for example, an A3 measurement event or an A5 measurement event. For specific content of the first condition, refer to the foregoing description.

In step 808, when there is a candidate cell satisfying the first condition, the terminal device uses the candidate cell as a target cell, releases a connection to the source cell, and performs synchronization with the target cell applying a corresponding configuration of the target cell, to complete the first handover.

The foregoing describes method embodiments of this application in detail with reference to FIG. 1 to FIG. 8. The following describes apparatus embodiments of this application in detail with reference to FIG. 9 to FIG. 12. It should be understood that the description of the method embodiments corresponds to the description of the apparatus embodiments, and therefore, for parts that are not described in detail, reference may be made to the foregoing method embodiments.

FIG. 9 is a schematic block diagram of a structure of a terminal device according to an embodiment of this application. A terminal device 900 shown in FIG. 9 may include a handover module 910.

The handover module 910 may be configured to perform a handover from a source cell to a target cell, where the handover is a first handover, and the first handover is a handover triggered based on layer-1/layer-2 signaling or measurement.

Optionally, the handover is determined based on the layer-1 measurement or layer-3 measurement.

Optionally, the handover is triggered based on first information received by the terminal device, and the first information is used to indicate the terminal device to perform a handover from the source cell to the target cell.

Optionally, the first information is carried in a medium access control MAC layer control element MAC CE message or downlink control information DCI.

Optionally, terminal device 900 may further include a transmitting module 920. The transmitting module 920 may be configured to transmit second information to the source cell, where the second information is used to report a first measurement result, and the first measurement result includes a layer-1 measurement result or a layer-3 measurement result; or the second information is used to indicate that the target cell satisfies a first condition, and the first condition is that the terminal device determines whether the target cell satisfies a condition for performing the handover/measurement reporting.

Optionally, the second information is carried in a MAC CE message or uplink control information UCI.

Optionally, the second information includes at least one of following information: an identifier of the target cell, a transmission configuration indicator TCI state of the target cell, or beam related information of the target cell.

Optionally, the handover is triggered based on a first condition, and the first condition is that the terminal device determines whether the target cell satisfies a condition for performing the handover/measurement reporting.

Optionally, the handover is determined based on the layer-1 measurement, and the first condition includes at least one of following conditions: at least one beam in a first beam set satisfies a first threshold; a block error rate BLER of the source cell exceeds a second threshold for N consecutive times, where N is a positive integer; a measurement value of at least one beam in a first beam set within a time T is less than/greater than a third threshold, where T>0; a difference between a measurement value of the source cell and a measurement value of the target cell is greater than a fourth threshold; a measurement value of the source cell is less than a fifth threshold, and a measurement value of the target cell is greater than a sixth threshold; or a measurement value of the source cell is greater than a seventh threshold, and a measurement value of the target cell is less than an eighth threshold.

Optionally, the first beam set includes at least one of following: a synchronization signal block SSB; a channel state information-reference signal CSI-RS; or an uplink sounding reference signal SRS.

Optionally, the handover is determined based on layer-3 measurement, and the first condition includes an A3 measurement event or an A5 measurement event.

Optionally, the terminal device may further include a receiving module 930. The receiving module 930 may be configured to receive handover configuration information transmitted by the source cell, where the handover configuration information includes configuration information of at least one candidate cell, and the target cell is one cell of the at least one candidate cell.

Optionally, the handover configuration information further includes a first condition corresponding to the at least one candidate cell, and the first condition is that the terminal device determines whether the at least one candidate cell satisfies a condition for performing the handover/measurement reporting.

Optionally, the handover configuration information is carried in a radio resource control RRC reconfiguration message.

Optionally, the source cell is distinguished from the target cell by using at least one of following: different cell identifiers; different transmission-reception points TRPs; different reference signal sets; different resources; different hybrid automatic repeat request HARQ processes; different protocol stacks; or different TCI states.

The terminal device 900 shown in FIG. 9 may be configured to implement any one of the wireless communication methods shown in FIG. 4 to FIG. 8. An implementation process thereof is the same as content related to the previous methods. For details, refer to the embodiments shown in FIG. 4 to FIG. 8. Details are not described herein again.

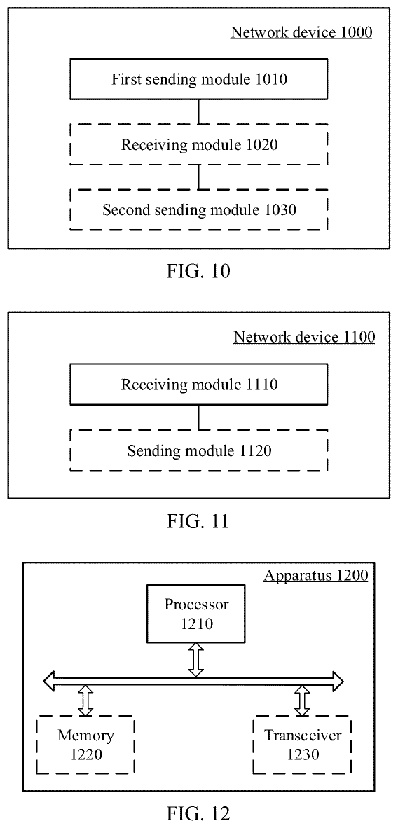

FIG. 10 is a schematic block diagram of a structure of a network device according to an embodiment of this application. The network device shown in FIG. 10 may be a network device to which a source cell belongs. The network device 1000 may include a first transmitting module 1010.

The first transmitting module 1010 may be configured to transmit a handover request to a target cell, where the handover request is used to perform a handover of a terminal device from the source cell to the target cell, the handover is a first handover, and the first handover is a handover triggered based on layer-1/layer-2 signaling or measurement.

Optionally, the handover is determined based on the layer-1 measurement or layer-3 measurement.

Optionally, the handover is triggered based on first information received by the terminal device, and the first information is used to indicate the terminal device to perform a handover from the source cell to the target cell.

Optionally, the first information is carried in a medium access control MAC layer control element MAC CE message or downlink control information DCI.

Optionally, the network device 1000 may further include a receiving module 1020. The receiving module 1020 may be configured to receive second information transmitted by the terminal device, where the second information is used to report a first measurement result, and the first measurement result includes a layer-1 measurement result or a layer-3 measurement result; or the second information is used to indicate that the target cell satisfies a first condition, and the first condition is that the terminal device determines whether the target cell satisfies a condition for performing the handover/measurement reporting.

Optionally, the second information is carried in a MAC CE message or uplink control information UCI.

Optionally, the second information includes at least one of following information: an identifier of the target cell, a transmission configuration indicator TCI state of the target cell, or beam related information of the target cell.

Optionally, the handover is triggered based on a first condition, and the first condition is that the terminal device determines whether the target cell satisfies a condition for performing the handover/measurement reporting.

Optionally, the handover is determined based on the layer-1 measurement, and the first condition includes at least one of following conditions: at least one beam in a first beam set satisfies a first threshold; a block error rate BLER of the source cell exceeds a second threshold for N consecutive times, where N is a positive integer; a measurement value of at least one beam in a first beam set within a time T is less than/greater than a third threshold, where T>0; a difference between a measurement value of the source cell and a measurement value of the target cell is greater than a fourth threshold; a measurement value of the source cell is less than a fifth threshold, and a measurement value of the target cell is greater than a sixth threshold; or a measurement value of the source cell is greater than a seventh threshold, and a measurement value of the target cell is less than an eighth threshold.

Optionally, the first beam set includes at least one of following: a synchronization signal block SSB; a channel state information-reference signal CSI-RS; or an uplink sounding reference signal SRS.

Optionally, the handover is determined based on the layer-3 measurement, and the first condition includes an A3 measurement event or an A5 measurement event.

Optionally, the network device 1000 may further include a second transmitting module 1030. The second transmitting module 1030 may be configured to transmit handover configuration information to the terminal device, where the handover configuration information includes configuration information of at least one candidate cell, and the target cell is one cell of the at least one candidate cell.

Optionally, the handover configuration information further includes a first condition corresponding to the at least one candidate cell, and the first condition is that the terminal device determines whether the at least one candidate cell satisfies a condition for performing the handover/measurement reporting.

Optionally, the handover configuration information is carried in a radio resource control RRC reconfiguration message.

Optionally, the source cell is distinguished from the target cell by using at least one of following: different cell identifiers; different transmission-reception points TRPs; different reference signal sets; different resources; different hybrid automatic repeat request HARQ processes; different protocol stacks; or different TCI states.

The network device 1000 shown in FIG. 10 may be configured to implement any one of the wireless communication methods shown in FIG. 4 to FIG. 8. An implementation process thereof is the same as content related to the previous methods. For details, refer to the embodiments shown in FIG. 4 to FIG. 8. Details are not described herein again.

FIG. 11 is a schematic block diagram of a structure of a network device according to another embodiment of this application. The network device shown in FIG. 11 may be a network device to which a target cell belongs. The network device 1100 may include a receiving module 1110.

The receiving module 1110 may be configured to receive a handover request transmitted by a source cell, where the handover request is used to perform a handover of a terminal device from the source cell to the target cell, the handover is a first handover, and the first handover is a handover triggered based on layer-1/layer-2 signaling or measurement.

Optionally, the handover is determined based on the layer-1 measurement or layer-3 measurement.

Optionally, the handover is triggered based on first information received by the terminal device, and the first information is used to indicate the terminal device to perform a handover from the source cell to the target cell.

Optionally, the first information is carried in a medium access control MAC layer control element MAC CE message or downlink control information DCI.

Optionally, the handover is triggered based on a first condition, and the first condition is that the terminal device determines whether the target cell satisfies a condition for performing the handover/measurement reporting.

Optionally, the handover is determined based on the layer-1 measurement, and the first condition includes at least one of following conditions: at least one beam in a first beam set satisfies a first threshold; a block error rate BLER of the source cell exceeds a second threshold for N consecutive times, where N is a positive integer; a measurement value of at least one beam in a first beam set within a time T is less than/greater than a third threshold, where T>0; a difference between a measurement value of the source cell and a measurement value of the target cell is greater than a fourth threshold; a measurement value of the source cell is less than a fifth threshold, and a measurement value of the target cell is greater than a sixth threshold; or a measurement value of the source cell is greater than a seventh threshold, and a measurement value of the target cell is less than an eighth threshold.

Optionally, the first beam set includes at least one of following: a synchronization signal block SSB; a channel state information-reference signal CSI-RS; or an uplink sounding reference signal SRS.

Optionally, the handover is determined based on layer-3 measurement, and the first condition includes an A3 measurement event or an A5 measurement event.

Optionally, the network device 1100 may further include a transmitting module 1120. The transmitting module 1120 may be configured to transmit a response message for the handover request to the source cell, where the response message for the handover request includes configuration information of the target cell.

Optionally, the source cell is distinguished from the target cell by using at least one of the following: different cell identifiers; different transmission-reception points TRPs; different reference signal sets; different resources; different hybrid automatic repeat request HARQ processes; different protocol stacks; or different TCI states.

The network device 1100 shown in FIG. 11 may be configured to implement any one of the wireless communication methods shown in FIG. 4 to FIG. 8. An implementation process thereof is the same as content related to the previous methods. For details, refer to the embodiments shown in FIG. 4 to FIG. 8. Details are not described herein again.

FIG. 12 is a schematic structural diagram of a communication apparatus according to an embodiment of this application. The dashed lines in FIG. 12 indicate that the unit or module is optional. The apparatus 1200 may be configured to implement the methods described in the method embodiments. The apparatus 1200 may be a chip, a terminal device, or a network device.

The apparatus 1200 may include one or more processors 1210. The processor 1210 may allow the apparatus 1200 to implement the methods described in the foregoing method embodiments. The processor 1210 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1200 may further include one or more memories 1220. The memory 1220 stores a program that may be executed by the processor 1210 to cause the processor 1210 to perform the methods described in the foregoing method embodiments. The memory 1220 may be independent of the processor 1210 or may be integrated into the processor 1210.

The apparatus 1200 may further include a transceiver 1230. The processor 1210 may communicate with another device or chip through the transceiver 1230. For example, the processor 1210 may transmit and receive data to and from another device or chip through the transceiver 1230.

An embodiment of this application further provides a computer-readable storage medium for storing a program. The computer-readable storage medium may be applied to the terminal or the network device provided in embodiments of this application, and the program causes a computer to perform the methods performed by the terminal or the network device in various embodiments of this application.

An embodiment of this application further provides a computer program product. The computer program product includes a program. The computer program product may be applied to the terminal or the network device provided in embodiments of this application, and the program causes a computer to perform the methods performed by the terminal or the network device in various embodiments of this application.

An embodiment of this application further provides a computer program. The computer program may be applied to the terminal or the network device provided in embodiments of this application, and the computer program causes a computer to perform the methods performed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In embodiments of this application, “B corresponding to A” means that B is associated with A, and B may be determined based on A. However, it should be further understood that, determining B based on A does not mean determining B based only on A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” can be implemented by prestoring corresponding code or a corresponding table in a device (for example, including the terminal device and the network device) or in other manners that can be used for indicating related information, and a specific implementation thereof is not limited in this application. For example, “predefining” may refer to being defined in a protocol.

In embodiments of this application, the “protocol” may refer to a standard protocol in the communication field, which may include, for example, an LTE protocol, an NR protocol, and a related protocol applied to a future communications system, and this application is not limited in this regard.

In embodiments of this application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. Finally, it should be noted that the foregoing displayed or discussed mutual coupling or direct coupling or communication connections may be implemented by using some interfaces. Indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of the embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
performing, by a terminal device, a handover from a source cell to a target cell, wherein the handover is a first handover, and the first handover is a handover triggered based on layer-1/layer-2 signaling or measurement.

2. The method according to claim 1, wherein the handover is determined based on the layer-1 measurement or layer-3 measurement.

3. The method according to claim 1, wherein the handover is triggered based on first information received by the terminal device, and the first information is used to indicate the terminal device to perform a handover from the source cell to the target cell.

4. The method according to claim 3, wherein the first information is carried in a medium access control control element (MAC CE) message or downlink control information (DCI).

5. The method according to claim 3, wherein the method further comprises:
transmitting, by the terminal device, second information to the source cell, wherein the second information is used to report a first measurement result, and the first measurement result comprises a layer-1 measurement result or a layer-3 measurement result; or the second information is used to indicate that the target cell satisfies a first condition, and the first condition is that the terminal device determines whether the target cell satisfies a condition for performing the handover/measurement reporting.

6. The method according to claim 5, wherein the second information is carried in a MAC CE message or uplink control information (UCI).

7. The method according to claim 1, wherein before the performing, by a terminal device, a handover from a source cell to a target cell, the method further comprises:
receiving, by the terminal device, handover configuration information transmitted by the source cell, wherein the handover configuration information comprises configuration information of at least one candidate cell, and the target cell is one cell of the at least one candidate cell.

8. A wireless communication method, comprising:
transmitting, by a source cell, a handover request to a target cell, wherein the handover request is used to perform a handover of a terminal device from the source cell to the target cell, the handover is a first handover, and the first handover is a handover triggered based on layer-1/layer-2 signaling or measurement.

9. The method according to claim 8, wherein the handover is determined based on the layer-1 measurement or layer-3 measurement.

10. The method according to claim 8, wherein the handover is triggered based on first information received by the terminal device, and the first information is used to indicate the terminal device to perform a handover from the source cell to the target cell.

11. The method according to claim 10, wherein the first information is carried in a medium access control control element (MAC CE) message or downlink control information (DCI).

12. The method according to claim 10, wherein the method further comprises:
receiving, by the source cell, second information transmitted by the terminal device, wherein the second information is used to report a first measurement result, and the first measurement result comprises a layer-1 measurement result or a layer-3 measurement result; or the second information is used to indicate that the target cell satisfies a first condition, and the first condition is that the terminal device determines whether the target cell satisfies a condition for performing the handover/measurement reporting.

13. The method according to claim 12, wherein the second information is carried in a MAC CE message or uplink control information (UCI).

14. The method according to claim 8, wherein the source cell is distinguished from the target cell by using at least one of following:
different cell identifiers;
different transmission-reception points (TRPs);
different reference signal sets;
different resources;
different hybrid automatic repeat request (HARQ) processes;
different protocol stacks; or
different TCI states.

15. A terminal device, comprising a memory and a processor, wherein the memory is configured to store a program, and the processor is configured to invoke the program in the memory to cause the terminal device at least to:
perform a handover from a source cell to a target cell, wherein the handover is a first handover, and the first handover is a handover triggered based on layer-1/layer-2 signaling or measurement.

16. The terminal device according to claim 15, wherein the handover is determined based on the layer-1 measurement or layer-3 measurement.

17. The terminal device according to claim 15, wherein the handover is triggered based on first information received by the terminal device, and the first information is used to indicate the terminal device to perform a handover from the source cell to the target cell.

18. The terminal device according to claim 17, wherein the first information is carried in a medium access control control element (MAC CE) message or downlink control information (DCI).

19. The terminal device according to claim 17, wherein the terminal device further comprises:
a transmitting module, configured to transmit second information to the source cell, wherein the second information is used to report a first measurement result, and the first measurement result comprises a layer-1 measurement result or a layer-3 measurement result; or the second information is used to indicate that the target cell satisfies a first condition, and the first condition is that the terminal device determines whether the target cell satisfies a condition for performing the handover/measurement reporting.

20. The terminal device according to claim 19, wherein the second information is carried in a MAC CE message or uplink control information (UCI).
